(19) United States
(12) Patent Application Publication
(10) Pub. No.: US 2006/0036845 A1
(43) Pub. Date: Feb. 16, 2006

(54) Embedded software operating method and hardware architecture of portable drive

(76) Inventor: Chung Won Shu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/960,907

(22) Filed: Oct. 12, 2004

(30) Foreign Application Priority Data
Jul. 30, 2004 (TW) 093122834

(51) Int. Cl. G06F 1/24

(52) U.S. Cl. 713/100

(57) ABSTRACT

The present invention pertains to embedded software operating method and an embedded hardware architecture of a portable drive, which provides operating software to realize the operating method of the present invention; the operating software is built in a storage device of a general portable drive in order to cooperate with the hardware architecture and perform its functions. The process of the operating method of the present invention is designed to be that once the portable drive is engaged with an operating computer, the operating software will actively take the control power over the portable drive, and then compares contents of specified files in a hard disc of the operating computer with that of the portable drive, and then utilizes a mapping treatment method, provided by the present invention, to creates corresponding mapping files, and then creates associative index files for the specified files, and then dynamically traces changes in the hard disc of the operating computer, and instantaneously updates the corresponding mapping files and associative index files thus to enable the portable drive to achieve an objective of active update; while the portable drive is disengaged from the operating computer and engaged to a target computer, the operating software will actively duplicate the associative index files onto the target computer; via the associative index files and an address-translation, and in cooperation with a graphical user interface, the operating software provides a more convenient mode to directly access the corresponding mapping files of the portable drive. The present invention also provides an optional function of encrypting and compressing treatment, which is a combination of 128-bit encoding format and RC2 encoding algorithm. The present invention further provides an operating method to lock/unlock the screen and keyboard of a computer and to enable the portable drive to function as a lock/unlock key, and thus file security is promoted.

### BACKGROUND OF THE INVENTION

(a) Field of the Present Invention

The present invention relates to an embedded software operating method and an embedded hardware architecture of a portable drive, particular to those which actively update specified files of an operating computer and enable an user's operating environment to be conveniently carried about.

(b) Description of Related Art

The development of the portable drive makes a data backup released from capacity limit of a floppy disc or inconvenience of carrying a removable hard disc module. The exploitation of a variety of memory media further accelerates the technological advance of the portable drive. In the current market, there has been numerous specifications of portable drives to be selected, and reduction in the volume and weigh thereof makes those more conveniently carried about than the traditional removable hard discs.

As shown in FIG. 1, a conventional portable drive 1 at least comprises a transmission interface 11, a storage device 12 and a control chip 13. The transmission interface 11 is an interface for transferring instructions and files, and the more prevailing specifications thereof include USB2.0, USB OTG (On The Go), wireless USB, IEEE1394, SATA (Serial ATA) etc. The storage device 12 is usually a hard disc, or a chip or memory card made of a flash memory. The control chip 13 controls the access operations of the storage device 12. It is to be noted that once the conventional portable drive 1 engaged to a computer, the control power of the control chip 13 is completely given to the computer, and the control chip 13 can only execute the tasks instructed by the computer. Such a passive mode of receiving and executing access instructions makes the conventional portable drive 1 an extensive drive of the computer. For example, an user can duplicate a mail-related file 211 or a web-page-shortcut-related file 212 in a hard disc 2 of an operating computer to the conventional portable drive 1 as a mail-related file backup 141 and a web-page-shortcut-related file backup 142, and these backup files are carried about and then duplicated to a hard disc 2′ of a target computer; however, according to the interactive relation of the internal elements illustrated in FIG. 1, as the file transmission is of a bi-directional mode and the instruction transmission is of an unidirectional mode, if there is a newer version of a file in the hard disc 2 of the operating computer, the corresponding update to the conventional portable drive 1 for carrying-about later is to be manually operated by the user himself. For the frequently-used mail-related file 211 and web-page-shortcut-related file 212, it is an inconvenient backup and carry about method.

### SUMMARY OF THE PRESENT INVENTION

The primary objective of the present invention is to provide an embedded software operating method of a portable drive, which promotes the function of the portable drive via an operating software, particularly an operating method that enables related setup files of the same mail accounts, address book and web-page shortcuts to be conveniently carried about and used in the other computers.

Another objective of the present invention is to provide an embedded hardware architecture of a portable drive, which promotes the function of the portable drive via a built-in operating software.

According to one aspect of the present invention, in order to achieve the aforementioned objectives, an embedded software operating method of the portable drive includes: taking an engagement of the portable drive and an operating computer as an initiating instruction to actively take over the control power of the portable drive; then scanning mail-related files and web-page-shortcut-related files in the hard disc of the operating computer; comparing the contents of the portable drive in order to create corresponding mapping files and associative index files; dynamically tracing the contents of the operating computer and instantaneously updating the corresponding mapping files and the corresponding associative index files of the portable drive; then disengaging the portable drive from the operating computer and engaging the portable drive to another desired target computer; duplicating the associative index files to the target computer; and once an access requirement referring to the mail-related files or the web-page-shortcut-related files in the target computer, translating address via the aforementioned associative index files and representing to the user via a graphical user interface (GUI). The present invention further provides an encrypting mechanism and a security mechanism to protect the file access. Thus, the software operating method of the portable drive of the present invention not only can actively updates the frequently-used mail-related files or web-page-shortcut-related files, but also has a function to carry about an user's operating environment. No matter which target computer is engaged with the portable drive of the present invention, the convenience will be promoted so greatly that the user can operate it as the original operating computer.

An embedded hardware architecture of the portable drive according to one aspect of the present invention is constructed by that an operating software, which can actively control the transmission and access operations of the portable drive, is written into the storage device of the portable drive as a built-in operating software to promote the function of the portable drive, in order to improve the prior art problem that the conventional portable drive can only passively receive transmission or access instructions. Besides, it is neither necessary to change the original architecture of the portable drive in large scale, nor to design anew or modify other internal elements; the present invention adopts the most easy and economic way of only building-in the operating software to promote the function of the hardware architecture of the portable drive.

### BRIEF DESCRIPTION OF THE DRAWINGS

FIG. 1 is a schematic diagram illustrating the interactive actions of the internal elements and the operation of file update in a conventional portable drive.

FIG. 2 is a schematic diagram illustrating the interactive actions of the internal elements and the operation of file update in a portable drive according to one embodiment of the present invention.

FIG. 3 is a flow chart illustrating a software control method according to one embodiment of the present invention.

FIG. 4 is a flow chart illustrating a mapping treatment according to one embodiment of the present invention.

FIG. 5 is a schematic diagram illustrating a graphical user interface according to one embodiment of the present invention.

FIG. 6A is a flow chart illustrating an encrypting/decrypting process according to one embodiment of the present invention.

FIG. 6B is a flow chart illustrating a process of locking/unlocking the screen and keyboard according to one embodiment of the present invention.

FIG. 7A is a flow chart illustrating a file-encrypting process according to one embodiment of the present invention.

FIG. 7B is a flow chart illustrating a file-decrypting process according to one embodiment of the present invention.

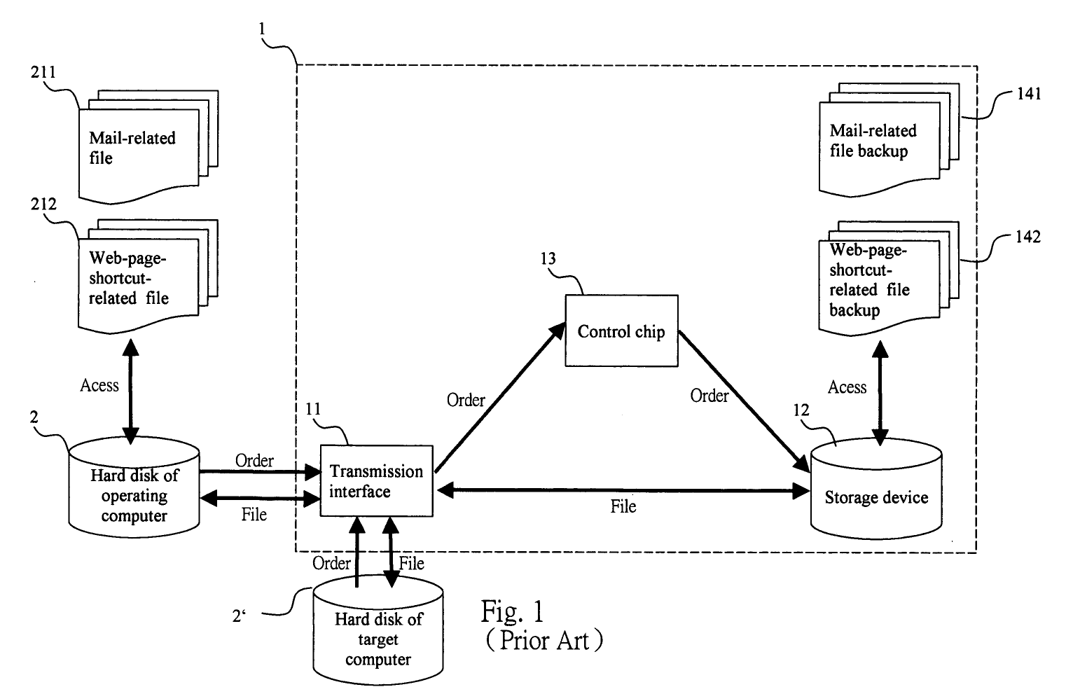

### LIST OF REFERENCE NUMERALS

The prior art
1 conventional portable drive
11 transmission interface
12 storage device
13 control chip
141 mail-related file backup
142 Web-page-shortcut-related file backup
2 hard disc of operating computer
2′ hard disc of target computer
211 mail-related file
212 Web-page-shortcut-related file

The present invention
2 hard disc of operating computer
2′ hard disc of target computer
211 mail-related file
212 Web-page-shortcut-related file
3 portable drive of the present invention
31 transmission interface
32 storage device
33 control chip
34 operating software
351 mail-related mapping file
352 Web-page-shortcut-related mapping file
353 associative index file

The process
S11 receiving linkage signal
S12 taking over the control power
S13 mapping treatment
S14 creating associative index file
S15 dynamic trace and an instantaneous update
S16 disengaged from operating computer
S21 engaged to target computer
S22 actively duplicating associative index file
S23 address-translation
S24 representation in graphical user interface
S25 accessing related mapping file
S26 disengaged from target computer

### PREFERRED EMBODIMENTS OF THE PRESENT INVENTION

The present invention is to provide an embedded software operating method of a portable drive, emphasizing the user's convenience, and characterized in that frequently-used mail-related files or web-page-shortcut-related files are actively updated, and further corresponding mapping files and associative index files are automatically created in order to enable an user's operating environment to be carried about; the representation in a graphical user interface furthermore increases the user's convenience, and characterized in that the optional functions of file-encryption or keyboard-lockup also promote the security of files.

The present invention also provides an embedded hardware architecture of a portable drive wherein an operating software which promotes the function of a control chip is build in an access device of the portable drive, characterized in that the functional promotion of the portable drive can be achieved with no necessity of a complicated modification of the internal elements.

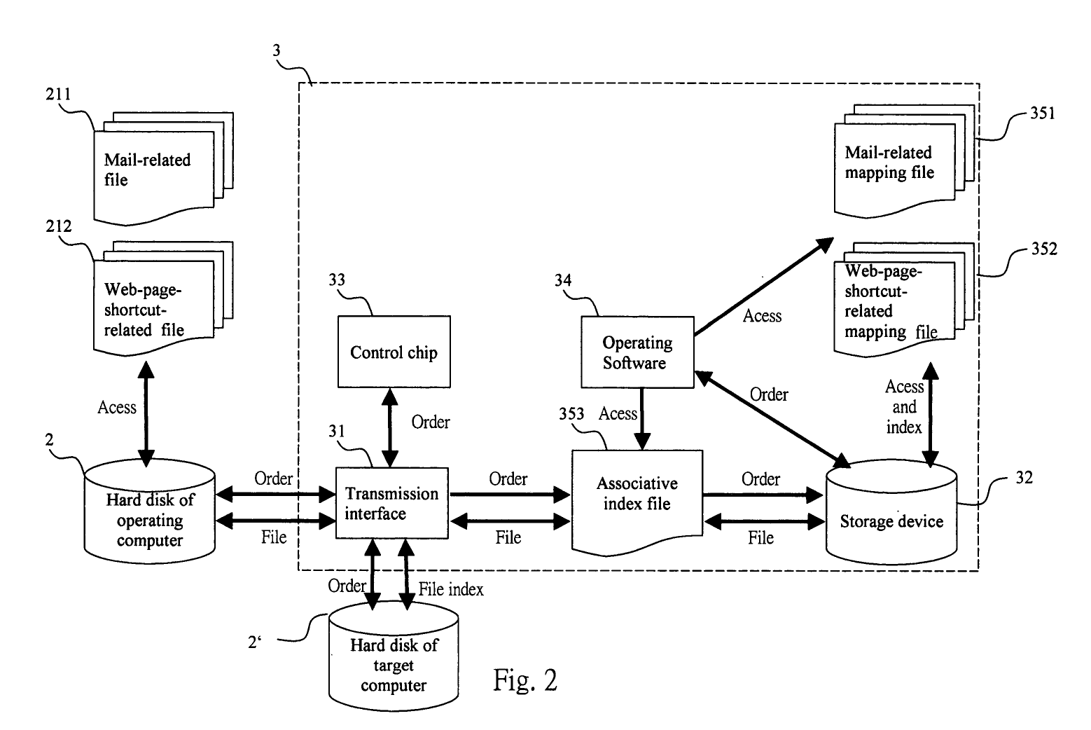

According to one embodiment of the present invention, as shown in FIG. 2, a portable drive 3 at least maintains a transmission interface 31, a storage device 32 and a control chip 33 similar to those also comprised in the conventional portable drive 1, and further an operating software 34 is built in the storage device 32 in order to promote the function of the control chip 33. The operating software 34 is one designed according to the operating method of the present invention, and functions as a medium between hardware and software, and will not take the place of the functions of any other elements in the portable drive 3, and contrarily, moderates each of those elements to perform and accomplish its own duty. From a microscopic view, the operating software 34 executes those trivial works for the user, such as duplication, paste, rename, creating a new file, etc.

Regarding the interactive actions of the internal elements of the portable drive 3, as shown in FIG. 2, the file transmission is still bi-directional; however owing to the active intervention of the operating software 34, the instruction transmission is no more only unidirectional but bi-directional sometimes. Further, a mail-related mapping file 351 and web-page-shortcut-related mapping file 352 enable a dynamic trace and an instantaneous update, which will be mentioned later, to be realized. Furthermore, the adoption of an associative index file 353 enables an address translation, which will be mentioned later, to be realized.

In summary, the operating method described above is accomplished partly via an actively-executing mechanism; therefore a design is needed, which enables the operating software 34 to intervene in moderating work of the portable drive 3 and take over a control power to execute some trivial works for the user and achieve the objective of active performance.

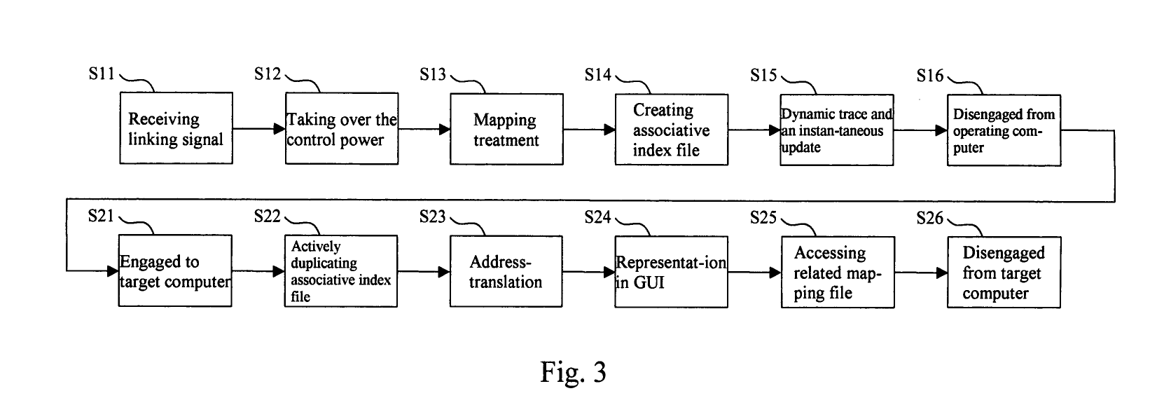

The operation of the elements of the present invention is shown in FIG. 2, and the flow chart of the operating method is shown in FIG. 3. The current embodiment describes a particular case. In general condition, a user should has a personal computer or a frequently-used computer for professional or personal utilization, which is to be called “operating computer” 2 here. Ordinarily, the portable drive 3 should mainly function as a medium to carry about the files originally existing in the operating computer 2.

Once the portable drive 3 is engaged to the operating computer 2, a linkage signal will be transferred by the transmission interface 31 through the storage device 32 to the operating software 34.

As the interactive actions of the internal elements shown in FIG. 2 and the step S11 and S12 in the flow chart of the operating method shown in FIG. 3, receiving the linkage signal functions as an initiating mechanism-step S11 to enable the step S12, the operating software 34's taking over the most high power of control inside the portable drive 3 with its priority level being promoted over the control chip 33. All the internal operations of the portable drive 3, mainly the access of files, should obey the top-priority instructions of the operating software 34 unless the operating software 34 is damaged or needn't perform. The instructions are issued by the operating software 34 and transferred through the transmission interface 31 to the control chip 33, and then the control chip 33 resolves the instructions into a permutation of simpler access steps, which are transferred through the transmission interface 31 to the storage device 32 in order to physically execute the access of the files. Similarly, the access operation between the portable drive 3 and the operating computer 2 is also via the transmission interface 31. In conclusion, the aforementioned operation is achieved via the operating software 34's directing or moderating each internal element of the portable drive 3. From a macroscopic view of the user, it is the so-called utilizing an operating software to achieve an automatically-executing and intelligent function of the portable drive 3.

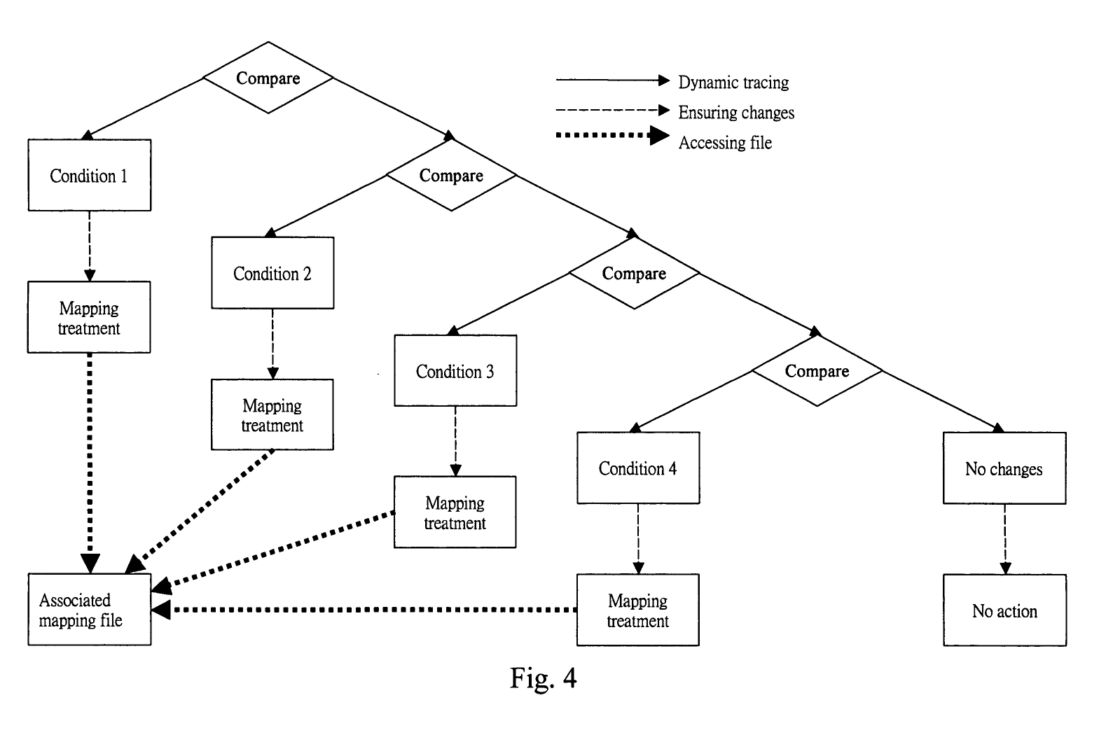

Then, the process proceeds to step S13 to undertake a mapping treatment, and the operating software 34 synchronously scans the storage device 32 and the target computer 2 in order to compare the user's mail-related (such as account, mails and address books) file 211 and the web-page-shortcut-related file 212 (for example, some TELNET, WWW, FTP or P2P application software are particularly equipped with a FAVORITE file to store the related information of the link paths or addresses which has been set up by the user). Then, as shown in FIG. 4, the following four cases are checked and executed in sequence, wherein
case 1: if some portion of the contents of the target computer's hard disc 2′ (referred to as target disc below) does not appear in the portable drive's storage device 32 (referred to as portable drive below), then the excess of the target disc 2′ is mapping-treated, and the mapping file is backuped to the portable drive 3;
case 2: if some portion of the portable drive 3 does not appear in the disc 2′, then the excess of the portable drive 3 is mapping-treated, and the mapping file is backuped to the target disc 2′;
case 3: if some portion of the target disc 2′ is newer than that of the portable drive 3, then the newer portion of the target disc 2′ is mapping-treated, and the mapping file is to cover the older portion of the portable drive 3;
case 4: if some portion of the portable drive 3 is newer than that of the target disc 2′, then the newer portion of the portable drive 3 is mapping-treated, and the mapping file is to cover the older portion of the target disc 2′.

The present invention emphasizes the portability of the operating environment relating to the mail-related file 211 and web-page-shortcut-related file 212. As the interactive actions of the internal elements shown in FIG. 2 and the step S14 in the operating flow chart shown in FIG. 3, an associative index file 353, which functions like a “shortcut”, or has a directive property, is created in step S14, and will act in the steps mentioned later.

As the interactive actions of the internal elements shown in FIG. 2 and the step S15 in the flow chart of the operating method shown in FIG. 3, a dynamic trace and an instantaneous update is performed in a manner that the change in the aforementioned files in the operating computer 2 is dynamically monitored, and the change of contents, name or format of the files in the operating computer 2 is responsively updated instantaneously and written into the corresponding mapping file and the associative index file 353. For example, in the current embodiment, if an address book in the mail-related file 211 of the operating computer 2 is modified, then the mail-related mapping file 351 of the portable drive 3 is correspondingly modified actively and instantaneously whether the user remembers or not to manually update and mapping-treat the modified file and write into the storage device 32 of the portable drive 3. The operating method provided by the present invention ensures that the aforementioned steps should have been completed physically without missing any data in the related files before the portable drive 3 is disengaged from the target computer.

Then the process proceeds to step S16, and the portable drive 3 is disengaged from the operating computer 2. While the portable drive 3 is carried about, there have been the mapping files of the mail-related file 211, web-page-shortcut-related file 212 and the corresponding associative index file 353 inside the portable drive 3.

As the interactive actions of the internal elements shown in FIG. 2 and the step S21, S22 and S23 in the flow chart of the operating method shown in FIG. 3, the portable drive 3 is engaged to hard disk of another target computer 2′, step S21, and then the portable drive 3 actively duplicates the associative index file 353 and stores it into hard disk of the target computer 2′, step S22. While the user opens the mail program, the associative index file 353, which has been duplicated and stored inside hard disk of the target computer 2′, will undertake an address-translation-step S23 to address-translate the mail-related file 211, which hard disk of the target computer 2′ intends to read, to the corresponding mail-related mapping file 351 of the portable drive 3. Similarly, while opening the web-page browser, the associative index file 353 will address-translate the web-page-shortcut-related file 212, which hard disk of the target computer 2′ intends to read, to the corresponding web-page-shortcut-related mapping file 352 of the portable drive 3.

Thus, no matter which computer the user may choose to use, once the portable drive 3 is engaged to a target computer, the aforementioned step S22-actively duplicating the associative index file 353 and storing it into hard disk of the target computer 2′ will be repeated, and via the associative index file 353, the setup files of mail and web-page will keep unchanged. Further, the software operating method of the present invention can ensure that there are always the newest versions of the files to be used, and it is needless to modify or backup additionally.

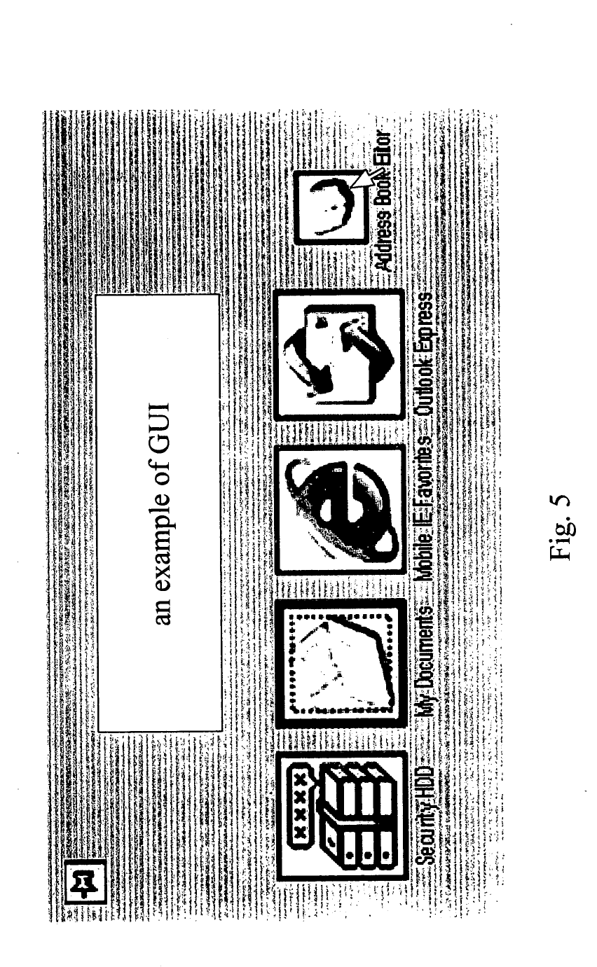

Then the process proceeds to step S24, which provides a representation manner of a graphical user interface. Its display screen is practically shown in FIG. 5, wherein the aforementioned mail-related file 211 and the web-page-shortcut-related file 212 are represented on the screen by icons. Just by clicking on the figural icons, the corresponding file will be opened, and the mail program or the web-page browser will be started; simultaneously, as shown in step S25, the access of the related mapping file is accomplished inside the portable drive 3 in order to provide a convenient and fast operating environment.

Then the process proceeds to step S26, and the portable drive 3 is disengaged from hard disk of the target computer 2′, and the files of the portable drive 3 still keeps in the newest state.

Thus, the operating software 34 of the present invention promotes the function of the portable drive to provide the user with a portable operating environment, which is adaptable to different target computers, and the user needn't spend his energy on the update or setup of the files.

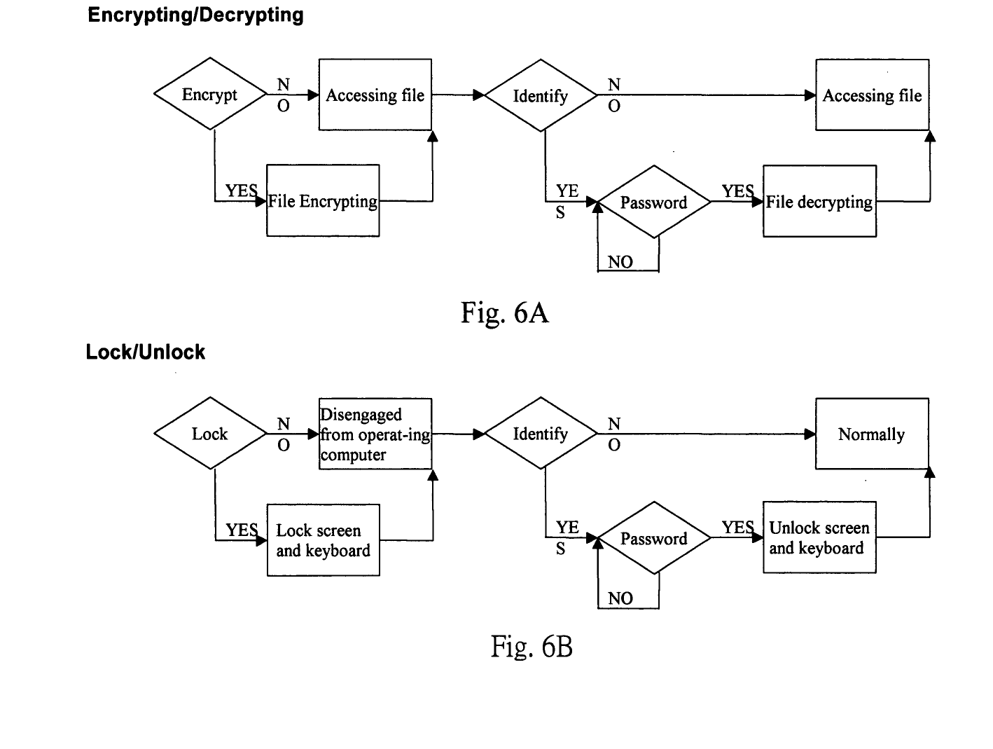

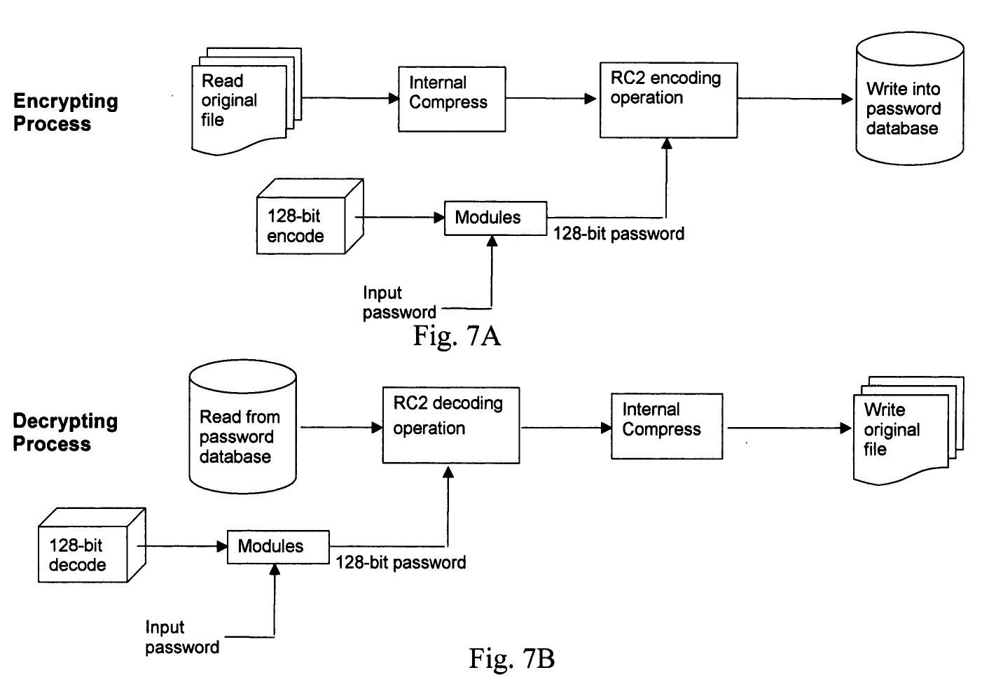

Further, according to another embodiment of the present invention, the operating software provides an additional function, as shown in FIG. 6A a flow chart thereof. The user can select from the optional items to determine whether a file is encrypted or not. If the selection is “NO”, the process will proceed as the ordinary access operation. If the selection is “YES”, the process will proceed according to the encrypting process as shown in FIG. 7A; an original file is read and then compressed into a compressed file by an internal compressing module. In the meanwhile, the user will be required to enter an encrypting password, which is encoded via a 128-bit encoding format and then integrated with the previous compressed file to be processed by a RC2 encoding operation. The encrypted compressed file is written into a password database in order to be read when necessary.

If the user intends to access the aforementioned encrypted compressed file, as shown in FIG. 3, once an encryption-identification procedure affirms an encrypted state of the file, entering a decrypting password will be required. It is only when the password is correct that the process proceeds to a file-decrypting procedure as shown in FIG. 7B. At first, the encrypted compressed file, which is previously stored in the password database, is read there from. At this time, the decrypting password is encoded via 128-bit encoding format and then integrated with the read encrypted compressed file to be processed by a RC2 decoding operation, and then the encrypted compressed file is restored into a decrypted compressed file which is then restored into a decompressed original file by the internal compressing module. Thus, the file is restored to an ordinarily accessible state.

Furthermore, according to yet another embodiment of the present invention, the operating software provides another additional function, as shown in FIG. 6B a flow chart thereof, wherein an optional item of lock function is provided. The optional item is to lock the screen and keyboard of the operating computer into a security mode. The lock/unlock operation needs to cooperate with a password also. If the optional item cooperates with the portable drive 3, the portable drive 3 will function as a carry about “key”, which can lock the screen and keyboard of the operating computer. Thus, the objective of promoting the security of the files is achieved.

If the user selects not to lock the screen and keyboard, the portable drive 3 can be disengaged directly. If the user decides to utilize the lock function and sets a password, then when the portable drive 3 is engaged to the locked operating computer, the operating software 34 will execute a lock-identification procedure. Once a locked state is affirmed, the user will be required to enter an unlocking password. If the password is correct, the screen and keyboard is unlocked; otherwise, the locked state will be maintained.

It is to be noted that the hardware architecture of the present invention is designed to build an operating software in a storage device inside the original architecture of a portable drive; however, the aforementioned storage device is not limited to a small-sized hard disc or a removable hard disc used by a notebook computer, but further including 2.5″, 1.8″, 1″ and further smaller portable hard discs; the portable drive of the present invention is a concept of general use, which refers to any kind of drives that are small-sized, conveniently carried about and easily installed; the operating method of the present invention is also adaptable to a flash memory and its derivative products; from a view of the hardware architecture, the idea of building an operating software inside a storage device is practicable, and the technology to realize the idea is also achievable.

The aforementioned detailed description according to the preferred embodiments is not intended to limit the scope of the present, and any equivalent modification or variation without departing from the technical spirit of the present invention is to be included within the scope of the present invention.

What is claimed is:

1. An embedded software operating method of a portable drive, including:
once receiving a signal of an engagement with an operating computer from a transmission interface, said embedded software operating method of said portable drive actively taking the control power over said portable drive;
scanning contents of mail-related files and a web-page-shortcut-related files in a hard disc of said operating computer, and comparing said contents with contents of said portable drive, and checking difference thereof, and then creating corresponding mapping files relating to both;
creating associative index files of said mail-related files and said web-page-shortcut-related files in said hard disc of said operating computer;
dynamically tracing an access state of said hard disc of said operating computer, and instantaneously updating said corresponding mapping files and said associative index files of said portable drive;
disengaging said portable drive from said operating computer, and engaging said portable drive to a target computer;
duplicating said associative index files in said portable drive onto a hard disc of said target computer;
while an access requirement referring to a mail-related file or a web-page-shortcut-related file in said hard disc of said target computer, via said duplicated associative index files, actively address-translating to related files of said portable drive, with the related setup and file contents in said hard disc of said target computer not involved or altered; and
disengaging said portable drive from said target computer.

2. The embedded software operating method of a portable drive according to claim 1, wherein said operating computer refers to a computer in which said mail-related file and said web-page-shortcut-related file are initially stored, and said target computer refers to a computer to which said portable drive is intended to be engaged.

3. The embedded software operating method of a portable drive according to claim 1, wherein said mail-related files is files in which files, including mail files, account setup files, and address book setup files, are stored.

4. The embedded software operating method of a portable drive according to claim 1, wherein said associative index files can be represented on the screen of said target computer in a manner of graphical user interface, and the user can directly click figural icons to access said mapping files in said portable drive.

5. The embedded software operating method of a portable drive according to claim 1, wherein said operating software can further utilize an internal compressing/decompressing and encrypting/decrypting operation to undertake a file encrypting/decrypting treatment for said portable drive.

6. The embedded software operating method of a portable drive according to claim 5, wherein said encrypting/decrypting operation is a combination of 128-bit encoding format and RC2 encoding algorithm.

7. The embedded software operating method of a portable drive according to claim 1, wherein said operating software can further lock/unlock the screen and keyboard of said operating computer in order to enter/cancel a security mode.

8. An embedded hardware architecture of a portable drive, including:
a control chip, controlling the basic transmission and access operation of files;
a storage device, being a medium for file storing
a transmission interface, linking said control chip and said storage device, and being a medium for file transferring; and
an operating software, which is built inside said portable drive to promote functions thereof, and in response to a sense of said transmission interface, actively takes a control power over said portable drive, and scans and compares mail-related files and web-page-shortcut-related files of an operating computer's hard disc and said portable drive, and then actively creates mapping files, and creates associative index files corresponding to said mail-related files and said web-page-shortcut-related files in said hard disc of said target computer, and dynamically traces contents in said hard disc of said target computer, and instantaneously updates said mapping files and said associative index files of said portable drive, and address-translates said mail-related files and said web-page-shortcut-related files to said mapping files of said portable drive.

9. The embedded hardware architecture of a portable drive according to claim 8, wherein said operating software is built inside said storage device.

10. The embedded hardware architecture of a portable drive according to claim 8, wherein said storage device is selected from a flash memory chip, a memory card or small-sized hard discs.

11. The embedded hardware architecture of a portable drive according to claim 8, wherein said transmission interface is selected from self-powered USB2.0, USB OTG (On The Go), wireless USB, IEEE394 or SATA (Serial ATA) interface.
